(19) United States
(12) Patent Application Publication
(10) Pub. No.: US 2006/0209537 A1
(43) Pub. Date: Sep. 21, 2006

(54) Display assembly with low voltage powered lighting

(75) Inventors: Gregory A. Stelmasik, Brooklyn Park, MN (US); W. Todd Crandell, Minnetonka, MN (US)

Correspondence Address: IPLM GROUP, P.A., POST OFFICE BOX 18455, MINNEAPOLIS, MN, 55418, US

(73) Assignee: Stylmark, Inc.

(21) Appl. No.: 11/083,349

(22) Filed: Mar. 17, 2005

(51) Int. Cl. F21S 4/00

(52) U.S. Cl. 362/217

(57) ABSTRACT

A display assembly with low voltage powered lighting includes a connection surface, a low voltage conductor, a power supply, and a board. The connection surface has a cavity and an aperture providing access to the cavity. The low voltage conductor is positioned within the cavity of the connection surface and is accessible through the aperture. The low voltage conductor is defined by 0.01 to 48.00 volts. The power supply is operatively connected to the low voltage conductor, and the power supply is set to 4 to 48 volts. The board includes a plurality of light emitting diodes and a driver. The driver interconnects the plurality of light emitting diodes and the low voltage conductor. The low voltage conductor provides power to any number of boards within the capability of the power supply.

### FIELD OF THE INVENTION

The present invention relates to a display assembly with low voltage powered lighting and, more specifically, to low voltage powered lighting utilizing light emitting diodes.

### BACKGROUND OF THE INVENTION

Display assemblies are commonly used in retail applications to display merchandise and are commonly arranged into banks of shelving displays or showcase displays. The shelving assemblies include slotted standards, which are vertically extending support structures mounted onto the wall display, and brackets may be positioned and repositioned at various locations along the slotted standards to adjust the height of the shelves supported by the brackets according to the preferences of the merchandisers. This allows for the shelves to be readily adjustable to accommodate different types of merchandise. Typically, the slotted standards are manufactured to an established industry profile width, depth, and material thickness determined by the loading and spacing requirements the shelves can support. The viewable width of an industry standard from the front, which is ¾ inch, gives an aesthetic and functional baseline that is generally agreed upon in the retail sales industry.

Lighting may be incorporated into the shelving assemblies to enhance the visibility of the merchandise displayed on the shelves. One way this can be accomplished is disclosed in U.S. Pat. No. 5,690,415, which is incorporated by reference herein. Lamps are operatively connected to the shelves, and the slotted standards are powered using line voltage. The shelves and the brackets are wired so that when the bracket engages the slotted standard the ballast/transformers are energized by the line voltage, which is preferably 110 volts, in the slotted standards, which in turn energizes the lamps. Line voltage requires different insulation distances and safety related geometry that do not allow for the use of the slotted standards manufactured to the industry profile. The line voltage powdered standards are designed for housing 110 volts and 15 amps of current and are wider than the ¾ inch wide industry standard.

To also enhance the visibility of the merchandise displayed on the shelving assemblies, a small shelf cross-sectional profile is desirable so as to not block the view of the merchandise. In a typical fluorescent or a LED display shelf, the ballast or the LED driver mounts to the shelves and adds to the cross-sectional area, which may detract from the overall ability to minimize blocking the view of the merchandise. Further, the greater the width of the shelf the more light sources are required to maintain illumination of the merchandise. Therefore, larger drivers or a larger number of drivers are required as the width of the shelf increases.

When the heights of the shelves must be adjusted to accommodate re-merchandizing, the shelving assemblies must be disconnected from the 110 volts source, which is typically a power cord connection to a power strip or a wall outlet. The power cord is visible and limits the distance to the power strip or the wall outlet. Although multiple outlets could be added, that would detract from the visual aesthetic of the display. Skilled electrical labor may be required in order to reinstall the electrical connection, which may detract from the ease of re-merchandizing the display.

Therefore, it is desired to provide a display assembly with lighting that has the modular flexibility to re-merchandise by adding or deleting the number of shelves and adjusting the heights of the shelves along the slotted standard without visible electrical cords or wires and to be able to use non-electrical trades to accomplish the change to the display. In addition, with regard to showcase displays comprising multiple showcases, it is desired to modularly add low voltage lighting without having to add drivers to each showcase.

### SUMMARY OF THE INVENTION

In one aspect of the present invention, an adjustable display assembly with low voltage powered lighting includes a standard, a low voltage conductor, a power supply, a bracket member, and a shelf member. The standard is manufactured to an industry profile width and depth and has a front portion and a cavity. The front portion has a plurality of apertures spaced a distance apart along the front portion, and the plurality of apertures provide access to the cavity. The low voltage conductor is positioned within the cavity of the standard and is accessible through the plurality of apertures along the front portion of the standard. The low voltage conductor is defined by 0.01 to 48.00 volts. The power supply is operatively connected to the low voltage connector. The bracket member has an engaging portion, a supporting portion, and a contact member. The engaging portion is configured and arranged to be inserted through at least one of the plurality of apertures and into the cavity to engage the standard. The contact member extends outward from the bracket member proximate the engaging portion, and the contact member is configured and arranged to contact the conductor within the cavity when the engaging portion engages the standard. The bracket member is adjustable along the front portion of the standard. The shelf member is supported by the bracket member and houses a lighting device. The lighting device is operatively connected to the contact member. The shelf member is adjustable with the bracket member along the front of the standard and the lighting device is activated when the contact member contacts the conductor.

In another aspect of the present invention, an adjustable display assembly with low voltage powered lighting for use with a standard manufactured to an industry profile width and depth includes a low voltage conductor, a power supply, a bracket member, and a housing member. The standard has a front portion and a cavity. The front portion has a plurality of apertures spaced a distance apart along the front portion, and the plurality of apertures provide access to the cavity. The low voltage conductor is positioned within the cavity of the standard and is accessible through the plurality of apertures along the front portion of the standard. The low voltage conductor is defined by 0.01 to 48.00 volts. The power supply is operatively connected to the low voltage connector, and the power supply is set to 4 to 48 volts. The bracket member has an engaging portion, a supporting portion, and a contact member. The engaging portion is configured and arranged to be inserted through at least one of the plurality of apertures and into the cavity to engage the standard. The contact member extends outward from the bracket member proximate the engaging portion and is configured and arranged to contact the conductor within the cavity when the engaging portion engages the standard. The bracket member is adjustable along the front portion of the standard. The housing member is supported by the bracket member and includes at least one light emitting diode and a driver. The driver interconnects the at least one light emitting diode and the contact member. The bracket member is adjustable and the at least one light emitting diode is activated when the contact member contacts the conductor.

In another aspect of the present invention, a display assembly with low voltage powered lighting includes a connection surface, a low voltage conductor, a power supply, and a board. The connection surface has a cavity and an aperture providing access to the cavity. The low voltage conductor is positioned within the cavity of the connection surface and is accessible through the aperture. The low voltage conductor is defined by 0.01 to 48.00 volts. The power supply is operatively connected to the low voltage conductor, and the power supply is set to 4 to 48 volts. The board includes a plurality of light emitting diodes and a driver. The driver interconnects the plurality of light emitting diodes and the low voltage conductor. The low voltage conductor provides power to any number of boards within the capability of the power supply.

In another aspect of the present invention, a display assembly with low voltage powered lighting includes a board, a low voltage conductor, and a power supply. The board includes a constant current driver circuit and at least one light emitting diode operatively connected to the constant current driver circuit. The low voltage conductor is defined by 0.01 to 48.00 volts and is operatively connected to the constant current driver circuit. The power supply is operatively connected to the low voltage connector, and the power supply is set to 4 to 48 volts.

In another aspect of the present invention, an adjustable display assembly with low voltage powered lighting includes a first standard, a second standard, a low voltage conductor, a power supply, a first bracket member, a second bracket member, and a housing member. The first standard is manufactured to an industry profile width and depth and has a first front portion and a first cavity. The first front portion has a first plurality of apertures spaced a distance apart along the first front portion providing access to the first cavity. The second standard is manufactured to an industry profile width and depth and has a second front portion and a second cavity. The second front portion has a second plurality of apertures spaced a distance apart along the second front portion providing access to the second cavity. The low voltage conductor is positioned within the first cavity of the first standard and is accessible through the first plurality of apertures along the first front portion of the first standard. The low voltage conductor is defined by 0.01 to 48.00 volts. The power supply is operatively connected to the low voltage connector and is configured and arranged to be connected to a 110 volts source. The power supply is set to 4 to 48 volts. The first bracket member has a first engaging portion, a first supporting portion, and a contact member. The first engaging portion is configured and arranged to be inserted through at least one of the first plurality of apertures and into the first cavity to engage the first standard. The contact member extends outward from the first bracket member proximate the first engaging portion, and the contact member is configured and arranged to contact the conductor within the first cavity when the first engaging portion engages the first standard. The first bracket member is adjustable along the first front portion of the first standard. The second bracket member has a second engaging portion and a second supporting portion. The second engaging portion is configured and arranged to be inserted through at least one of the second plurality of apertures and into the second cavity to engage the second standard. The second bracket member is adjustable along the second front portion of the second standard, and the shelf member is supported by the bracket member and the second bracket member. The housing member is supported by the first bracket member and the second bracket member. The housing member includes at least one light emitting diode and a driver. The driver interconnects the at least one light emitting diode and the contact member. The first bracket member and the second bracket member is adjustable and the at least one light emitting diode is activated when the contact member contacts the conductor.

### BRIEF DESCRIPTION OF THE DRAWINGS

FIG. 1 is an exploded perspective view of a low voltage powered standard constructed according to the principles of the present invention;

FIG. 1A is a top cross-section of the low voltage powered standard shown in FIG. 1;

FIG. 2 is an exploded perspective view of a display assembly comprising the low voltage powered standard shown in FIG. 1;

FIG. 3 is an exploded perspective view of a bracket assembly comprising a contact member of the display assembly shown in FIG. 2;

FIG. 3A is a side view of the bracket assembly shown in FIG. 3;

FIG. 4 is an exploded perspective view of a light emitting diode printed circuit board and a heat sink with wiring harness interconnects of the display assembly shown in FIG. 2;

FIG. 4A is a top view of the light emitting diode printed circuit board shown in FIG. 4;

FIG. 5 is a perspective view of the display assembly shown in FIG. 2 with a remote power supply;

FIG. 6 is an electrical schematic of the light emitting diode printed circuit board shown in FIG. 4A operatively connected to the bracket assembly shown in FIG. 3;

FIG. 7 is a cross-section of a low voltage powered shelf support constructed according to the principles of the present invention;

FIG. 7A is a side view of a bracket of the low voltage powered shelf support shown in FIG. 7;

FIG. 7B is a side view of an end cap of the low voltage powered shelf support shown in FIG. 7;

FIG. 8 is an electrical schematic for use with a low voltage display assembly;

FIG. 8A is a junction box for use with the electrical schematic shown in FIG. 8; and

FIG. 9 is a showcase display assembly for use with the electrical schematic shown in FIG. 8.

### DETAILED DESCRIPTION OF A PREFERRED EMBODIMENT

The present invention relates to adjustable display assemblies preferably utilizing industry slotted vertical standards and manufactured load supporting shelves having the ability to illuminate merchandise displayed on the shelves. A preferred embodiment adjustable display assembly constructed according to the principles of the present invention is designated by the numeral 10 in the drawings. A preferred embodiment showcase display assembly constructed according to the principles of the present invention is designated by the numeral 100 in the drawings.

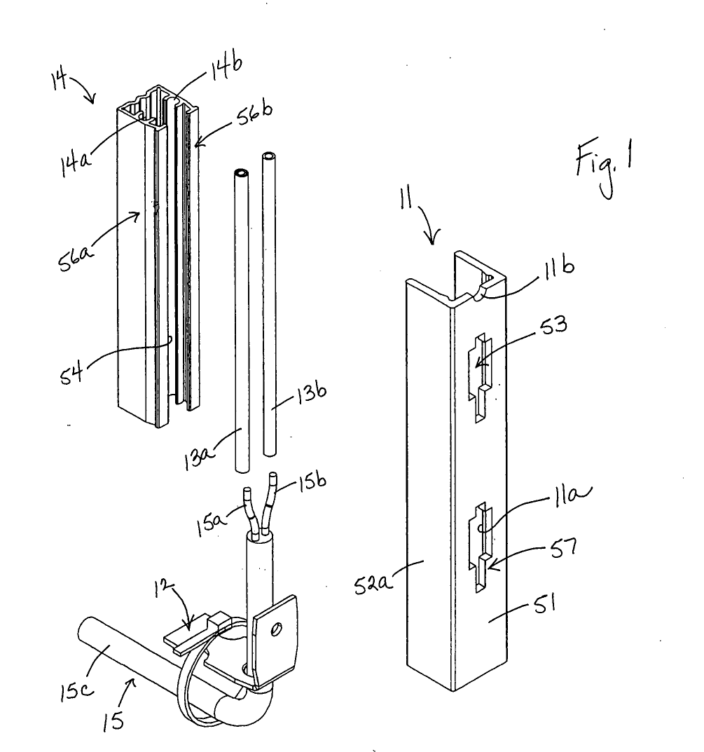

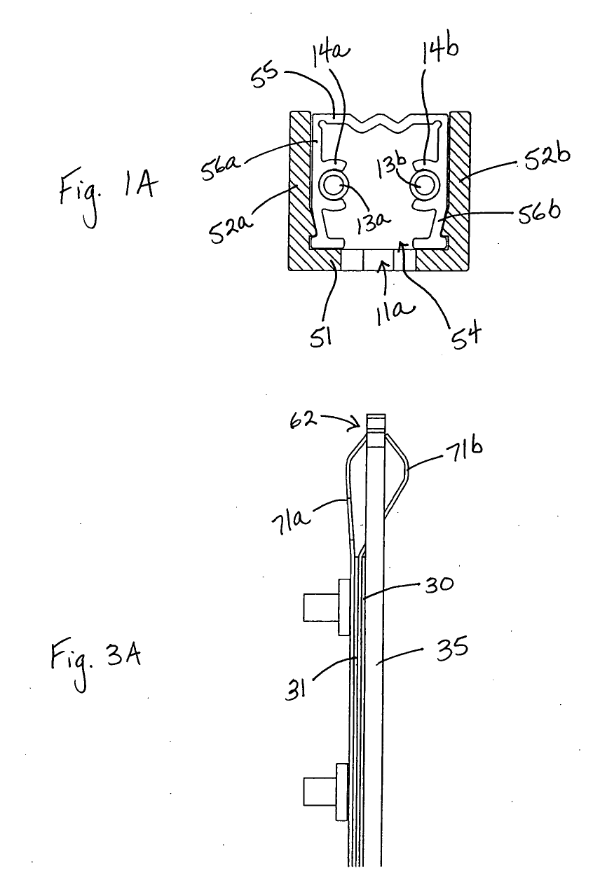

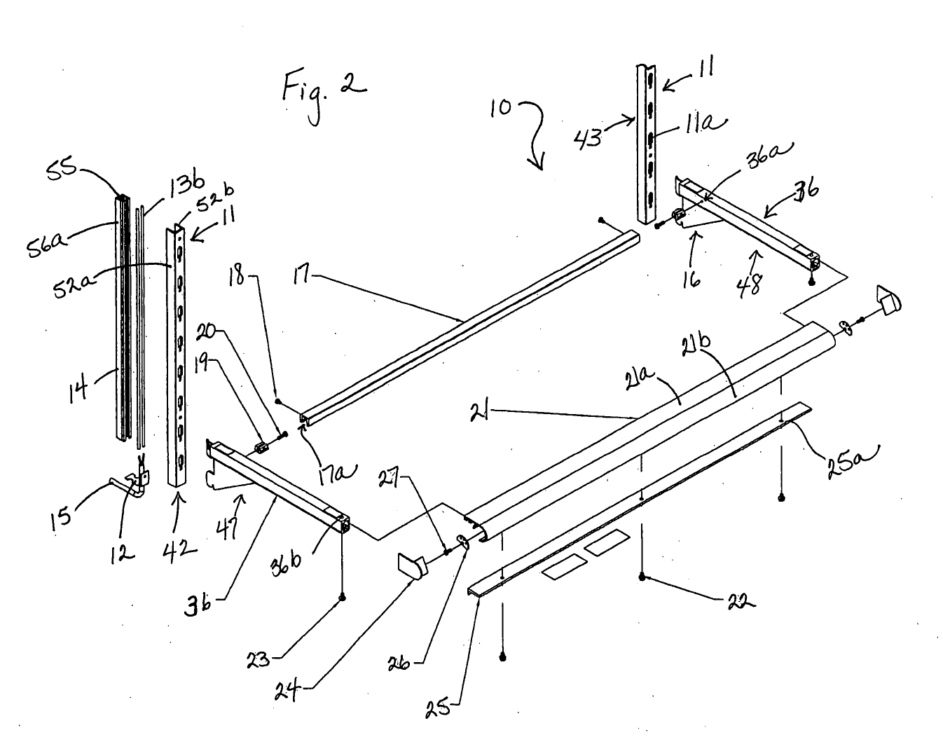

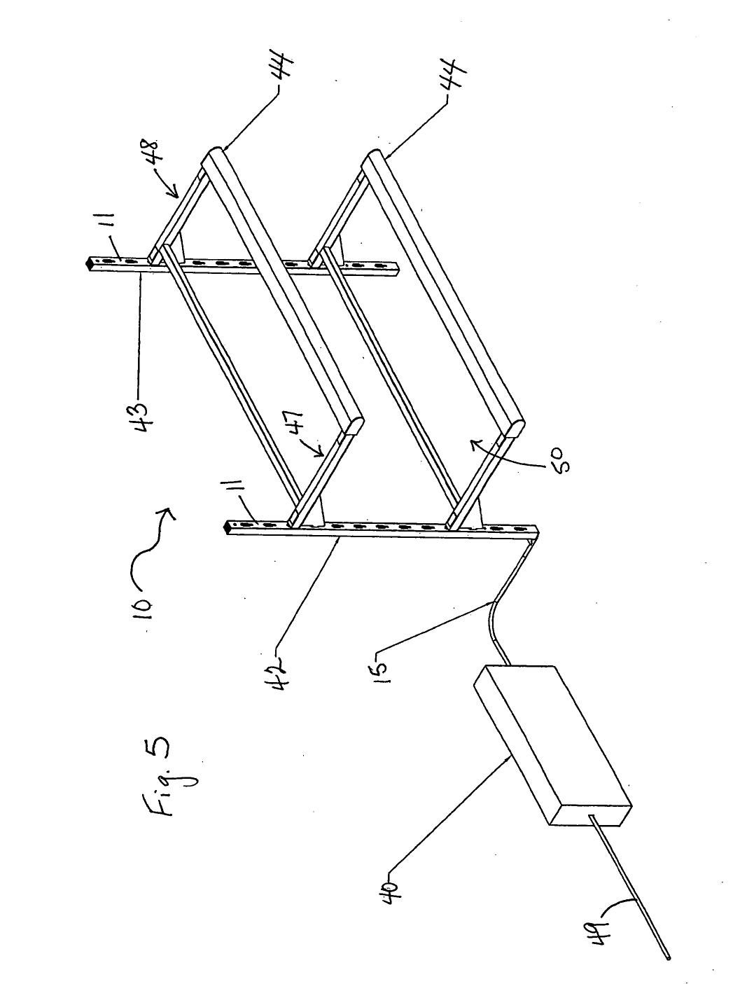

As shown in FIGS. 2 and 5, the adjustable display assembly 10 includes a standard 11, a bracket member 16, and a shelf member 50. With reference to FIGS. 1 and 2, the standard 11 is preferably manufactured to an established industry profile width, depth, and material thickness determined by the loading and spacing requirements the shelves can support. Most preferably, the standard is an elongate U-shaped member made of aluminum and the width is approximately ¾ inch, the depth is approximately ⅝ inch, and the material thickness is approximately 3/32 inch. The elongate U-shaped member is defined by side portions 52a and 52b interconnected by a front portion 51, which form a cavity 53 there between. The side portions 52a and 52b are preferably elongate plate members positioned parallel to one another, and the front portion 51 is an elongate plate member positioned perpendicular to the side portions 52a and 52b. The front portion 51 includes a plurality of apertures 11a providing access to the cavity 53 and spaced a distance apart along the front portion 51 of the standard 11. Preferably, the plurality of apertures 11a are spaced approximately 2 inches apart from one another and are generally “T” shaped with a wider portion proximate the top and a narrower portion proximate the bottom of the plurality of apertures 11a. The narrower portion of the plurality of apertures 11a forms a slot 57. In addition, the front portion 51 may include at least two apertures 11b through which fasteners (not shown) such as screws or other suitable fasteners may be inserted to operatively connect the standard 11 to a support structure such as a wall, a showcase, or other suitable support structure.

The standard 11 is powered with a low voltage conductor operatively connected to a power supply. FIGS. 1 and 5 show how the standard 11 is powered with electrodes 13a and 13b operatively connected to a power cable 15 having wires 15a and 15b and an interconnected portion 15c. The interconnected portion 15c houses and protects the wires 15a and 15b which are exposed on one end to connect to the tubular electrodes 13a and 13b. The wires 15a and 15b are connected to the electrodes 13a and 13b, respectively, by a mechanical crimp well known in the art. A strain relief bracket 12 is preferably operatively connected to the interconnected portion 15c by a metal tabbed plastic tie wrap and is positioned within the cavity 53 of the standard 11. The strain relief bracket 12 adds strength to the connection and reduces the risk of the wires 15a and 15b disconnecting from the electrodes 13a and 13b if the interconnected portion 15c is pulled. The strain relief bracket 12 and a segment of the power cable 15 proximate the strain relief bracket 12 fit within the cavity 53 of the standard 11 and are housed therein.

An insulator member 14 is an elongate U-shaped member configured and arranged to fit within the cavity 53 of the standard 11. The elongate U-shaped member is defined by side portions 56a and 56b interconnected by a back portion 55, which form a cavity 54 therebetween. The side portions 56a and 56b are preferably elongate plate members positioned parallel to one another, and the back portion 55 is an elongate plate member positioned perpendicular to the side portions 56a and 56b. The side portions 56a and 56b of the insulator member 14 opposite the back portion 55 include capturing details 14a and 14b, which are channels into which electrodes 13a and 13b, respectively, are frictionally held into place within the cavity 53 of the standard 11. The sides of the capturing details 14a and 14b are preferably flexible and deflect outward to accommodate and hold the electrodes 13a and 13b within the channels. This is shown in FIG. 1A. The capturing details 14a and 14b terminate proximate the edges of the plurality of apertures 11a to hold the electrodes 13a and 13b proximate the edges of the plurality of apertures 11a. Preferably, the insulator member 14 is made of polyvinyl chloride or any other suitable material well known in the art.

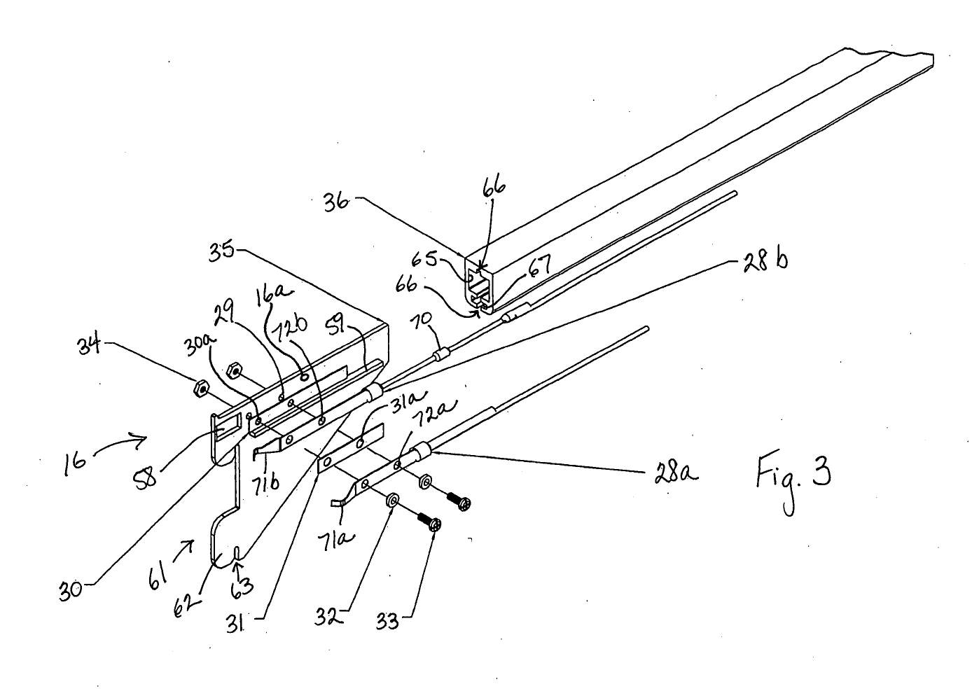

With reference to FIGS. 2 and 3, the bracket member 16 is preferably a plate member generally in the shape of a right triangle including an engaging portion 61 proximate one leg of the right triangle and a supporting portion 35 proximate the other leg of the right triangle. The edges of the engaging portion 61 and the supporting portion 35 are positioned approximately ninety degrees from one another. Preferably at least two hook portions 62 extend outward and downward from the engaging portion 61 creating a gap 63 between the hook portions 62 and the engaging portion 61.

The upper hook portion 62 of each bracket member 16 preferably includes an aperture 58. The hook portions 62 are each configured and arranged to be inserted through at least one of the plurality of apertures 11a and into the cavity 53 to engage the standard 11. The hook portions 62 are preferably inserted into adjacent apertures 11a so the hook portions 62 and the engaging portion 61 are on opposite sides of the standard 11 and the gaps 63 align with the respective slots 57. The bracket member 16 is then slid downward so the top surfaces of the gaps 63 are proximate the bottom surfaces of the slots 57 to attach the bracket member 16 to the standard 11. The gaps 63 are configured and arranged to accept and engage the front portion 51 of the standard, and the slots 57 are configured and arranged to accept and engage the hook portions 62 above the gaps 63.

The supporting portion 35 extends outward from the standard 11 at approximately ninety degrees. The bracket member 16 also includes at least two apertures 29 proximate the aperture 58 in the upper hook portion 62 and the supporting portion 35 aligned parallel to the supporting portion 35. An optional flange 59 extends across the bracket member 16 on both sides of the bracket member 16 below the apertures 29. The bracket member 16 is adjustable along the front portion 51 of the standard 11.

A contact member comprises a pair of contacts 28a and 28b, which are preferably electrical wires operatively connected to contact portions 71a and 71b having apertures 72a and 72b proximate the contact portions 71a and 71b, respectively. The contact 28b is also operatively connected to a fuse 70 proximate the contact portion 71b. The contact portions 71a and 71b are preferably elbow-like portions extending outward from one another, and the apertures 72a and 72b align with the apertures 29 of the bracket member 16. The contacts 28a and 28b are preferably operatively connected to one side of the bracket member 16 so that one of the contact portions extends through the aperture 58 of the upper hook portion 62 of the bracket member 16 and the other contact portion extends outward away from the bracket member 16, as shown in FIG. 3A. The contact portions 71a and 71b are configured and arranged to contact the electrodes 13a and 13b, respectively, within the cavity 53 when the hook portions 62 engage the standard 11.

The bracket member 16 and the contacts 28a and 28b must be insulated by sandwiching the contacts 28a and 28b between insulators 30 and 31, and one of the contacts also contains an in-line current limiting device (not shown) to limit the power. The insulators 30 and 31 are used to electrically isolate the contacts 28a and 28b from each other and the bracket member 16. The current limiting device is preferably soldered and shrink-wrapped and is an additional safety device to limit the current to 3 amps. With reference to FIG. 3, an insulator 30 having apertures 30a is placed between the bracket member 16 and the contact 28b, the apertures 30a aligning with the apertures 29 and 72b. An insulator 31 having apertures 31a is placed between the contact 28b and the contact 28a, the apertures 31a aligning with the apertures 72b and 72a. Insulators 30 and 31 are preferably rectangular pieces of polyethylene that electrically isolates the contacts 28a and 28b and the bracket member 16. Fasteners 33 must similarly also be insulated by placing fastener insulators 32 proximate the heads of fasteners 33. The fasteners 33 are inserted through the apertures 72a, 31a, 72b, 30a, and 29 and nuts 34 are secured to the ends of the fasteners 33 to secure the contacts 28a and 28b to the bracket member 16. The fasteners 33 are preferably screws, but it is recognized that studs, bolt welds, or any other suitable fasteners well known in the art may be used.

A shelf support 36 is preferably a square shaped tubular member including a bore 65, a bore 67, and a slot 66 extending longitudinally through the shelf support 36. The bore 65 is preferably rectangular shaped proximate the top of the shelf support 36 and the bore 67 is preferably rectangular shaped proximate the bottom of the shelf support 36. The longitudinal axis of the bores 65 and 67 are parallel to one another and are approximately perpendicular to the longitudinal axis of the slot 66. The slot 66 extends from the bottom of the shelf support 36, through the bore 67, through the bore 65, and upward from the bore 65 to provide access to the bores 67 and 65. The contacts 28a and 28b extend through the bore 65, and the slot 66 is configured and arranged to accept and engage the supporting portion 35 of the bracket member 16. The shelf support 36 includes an aperture 36a proximate the supporting portion 35 of the bracket member 16. The supporting portion 35 of the bracket member 16 is slid into the slot 66 of the shelf support 36, with the flange 59 slid into the bore 67, and a fastener 20 is inserted through a connector 19, through the aperture 36a in the shelf support 36, and through the aperture 16a in the bracket member 16.

As shown in FIG. 2, a rear shelf support 17 is an elongate U-shaped member having a cavity 17a. The rear shelf support 17 is operatively connected to the shelf supports 36 by placing the connectors 19 within the cavity 17a proximate the ends of the rear shelf support 17 and fastening the connectors 19 therein with fasteners 18.

A shelf member includes a housing member 21 and a plate member 50. The housing member 21 is preferably a light reflector. The housing member 21 includes a top front shelf support 21a and a curved portion 21b and is preferably made of a reflective material such as anodized aluminum. The top front shelf support 21a is preferably an elongate plate member, the ends of which are supported by the shelf supports 36 proximate the ends of the shelf supports 36. The curved portion 21b curves in a downward direction from the top front shelf support 21a. The top front shelf support 21a is operatively connected to the shelf supports 36 with fasteners 23 inserted through apertures 36b proximate the ends of the shelf supports 36 and into extruded screw ports (not shown) in the top front shelf support 21a. Fasteners 23 capture the shelf supports 36 through apertures 36b into the extruded screw ports of the top front shelf support 21a. Fasteners 27 fasten the brackets 26 to the ends of the heat sink 37 through the apertures 37a. The brackets 26 are configured and arranged to fit into axial grooves in the housing member 21 providing a means to position and orient the heat sink 37 in the housing member 21. The brackets 26 prevent the heat sink 37 from rotating within the housing member 21. The end caps 24 are configured and arranged to aesthetically enclose the ends of the housing member 21. The end caps 24 are friction fit into slots in the ends of the housing member 21.

A bottom front shelf support 25 is preferably an elongate plate member positioned below the top front shelf support 21a. The bottom front shelf support 25 includes apertures 25a through which fasteners 22 are inserted to secure the bottom front shelf support 25 to the top front shelf support 21a. The plate member 50 is preferably supported by the rear shelf support 17 and at least two shelf supports 36 operatively connected to bracket members 16 and then sandwiched between the bottom front shelf support 25 and the top front shelf support 21a. The plate member 50 is adjustable with the bracket members along the front portion of the standards. The plate member 50 is preferably made of glass and is configured and arranged to support merchandise displayed thereon. The housing member 21 is configured and arranged to house the lighting device 41.

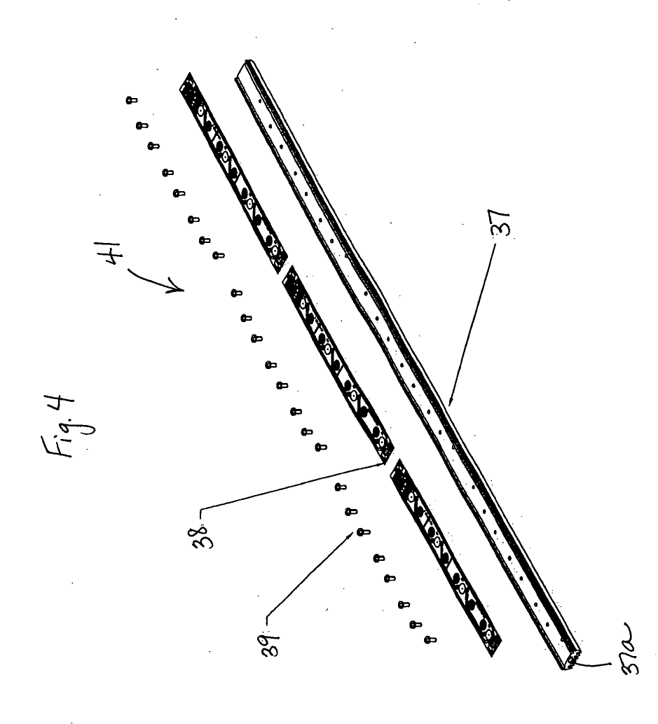

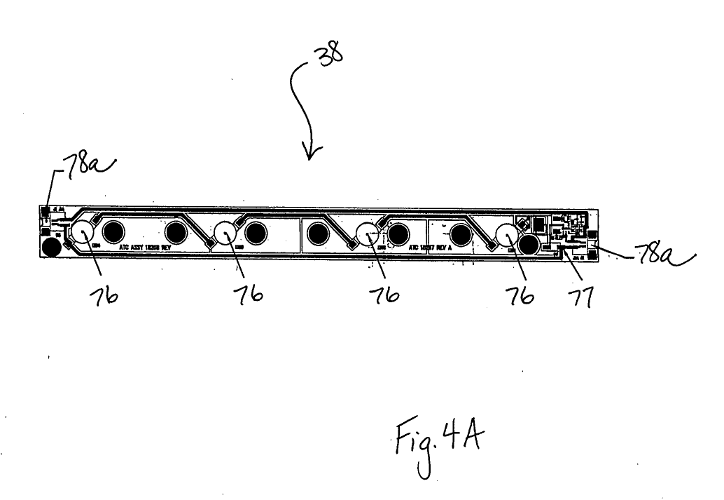

With reference to FIG. 4, the lighting device 41 includes a heat sink 37 and a plurality of LED printed circuit boards 38. The heat sink 37 provides a mounting surface for the LED printed circuit boards 38 and a functional method for controlling the heat of the LED printed circuit boards 38 with on-board constant current drivers. The LED printed circuit boards 38 are operatively connected to the heat sink 37 with fasteners 39 but could be attached by other suitable fastening methods known in the art. The lighting device 41, including the heat sink 37 and the LED printed circuit boards 38, is positioned within the curved portion 21b and is secured therein with brackets 26 and fasteners 27, as discussed above. An LED printed circuit board 38 is shown in more detail in FIG. 4A. The LED printed circuit board 38 includes a plurality of LED devices 76, a driver 77, and a connector receptacle 78a at each end of the board 38. The connectors 78 are placed within the connector receptacles 78a and operatively connect the LED printed circuit board 38 to another LED printed circuit board and/or to the electrical contacts of the bracket member with wires 78a.

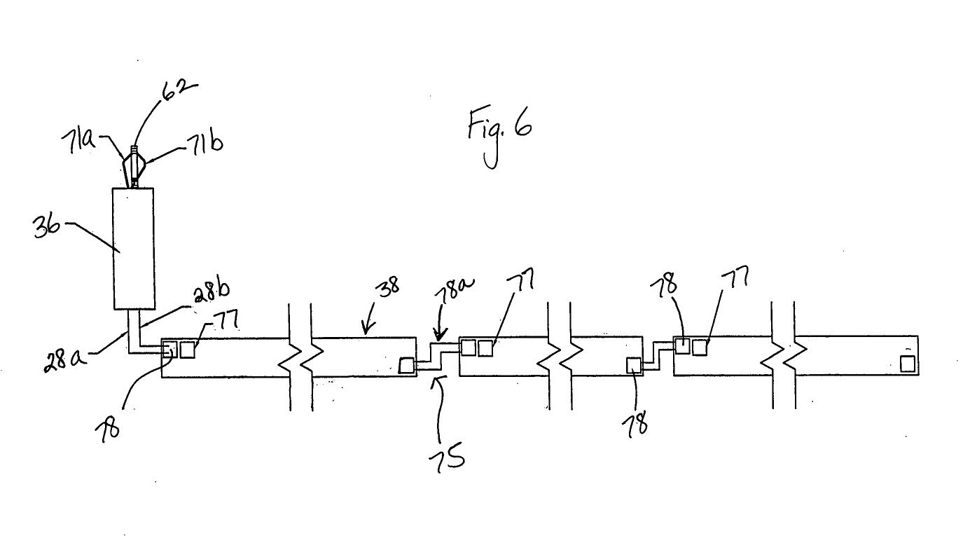

As shown in FIG. 6, three LED printed circuit boards 38 are operatively connected by harnesses 75. The harnesses 75 comprise two connectors 78 interconnected by wires 78a. To connect the LED printed circuit boards 38, the connectors 78 are placed within the connector receptacles 78a, and the wires 78a interconnecting the connectors 78 provide electrical connections between the boards 38. A connector 78 also connects one of the LED printed circuit boards 38 to wires 28a and 28b, which are connected to the contact portions 71a and 71b, which power the LED printed circuit boards 38 when they contact the electrodes 13a and 13b, respectively.

The present invention preferably utilizes low voltage lighting devices. Low voltage lighting devices are defined by 0.01 to 48.00 volts and can include many different power requirements and many different lighting devices. The voltage and current requirements vary depending upon the type of lighting devices and their luminous output. The lighting devices may include, but are not limited to, halogen, xenon, and LED type lighting devices. Although the present invention is described with regard to LED type lighting devices, it is recognized that other suitable types of lighting devices known in the art may be used.

Prior art low voltage lighting devices typically use a “driver” which regulates both the current to a fixed amount and provides a power level within the capacity of the assembly. The driver is contained in one discrete package. The power level capability of the driver determines the number of LED devices that can be utilized in the assembly. The driver is operatively connected to line current by an external power cord. Generally, a larger number of LED devices requires a larger amount of power while still maintaining a constant current level. Higher power LED drivers get larger and would further increase the cross-section of the shelf because the driver is located within the display shelf structure.

FIG. 5 shows the remote power supply 40 used with the adjustable display assembly 10 comprising two low voltage shelves 44, each supported on one side by a powered bracket member and shelf support 47 operatively connected a powered standard 42 and on the other side by a non-powered bracket member and shelf support 48 operatively connected to a non-powered standard 43. The remote power supply 40, the powered bracket member and shelf support 47, and the powered standard 42 provide power to the low voltage shelves 44. The remote power supply 40 is operatively connected to the power cable 15 and is configured and arranged to be connected to a 110 volts source (not shown) via the cord 49.

In operation, preferably at least two standards 11 are mounted onto a support structure and a bracket member 16 is operatively connected to each standard 11 to support the shelf member 50. Only one of the standards 11 and the corresponding bracket member 16 must be powered, but multiple standards 11 may be powered to accommodate higher electrical requirements for a great number of lighting devices used with the display assembly 10. One standard 11 houses the insulator member 14 holding the electrodes 13a and 13b, the strain relief bracket 12, and the segment of the power cable 15 proximate the strain relief bracket 12. This assembly forms a powered standard 42, only one of which is needed to power the display assembly 10. A powered bracket member 47 comprises a supporting portion 35, an engaging portion 61, hook portions 62, and a shelf support 36 with the electrical connections including the contact portions 71a and 71b. A non-powered standard 43 comprises a standard 11 and provides the mounting structure to which a non-powered bracket member 16 is operatively connected to support the opposite end of the shelf member 50. A non-powered bracket member 48 comprises a supporting portion 35, an engaging portion 61, hook portions 62, and a shelf support 36 without any electrical connections. Both standards 42 and 43 are mounted to a structure such as a wall or other suitable structure. The standards 42 and 43 are preferably mounted onto the structure by inserting fasteners such as screws through the apertures 11b and fastening the fasteners to the structure in such a way as to provide sufficient pull-out resistance to support the display assembly.

The powered bracket member 47 including the contact portions 71a and 71b is operatively connected to the standard 42, and the contact portions 71a and 71b contact the respective electrodes 13a and 13b to complete the electrical circuit and power the display assembly 10 and to support one end of the shelf member 50. The non-powered bracket member 48 is operatively connected to the standard 43 to support the other end of the shelf member 50.

The metal components of the display assembly 10 are preferably constructed from aluminum extrusions, aluminum sheet metal, or sheet steel to allow the display assembly to be anodized or painted. It is recognized that the construction techniques of these components vary slightly from aluminum to steel.

In another aspect of the present invention, a display assembly 100 includes a showcase, which is preferably a rectangular housing within which merchandise is displayed, preferably with one to four sides made of glass and the remaining sides made of any suitable material well known in the art. Showcases are well known in the art. Lighting is typically used to illuminate the merchandise displayed in the showcase, and shelving may also be used within the showcase to arrange the merchandise at different levels within the showcase.

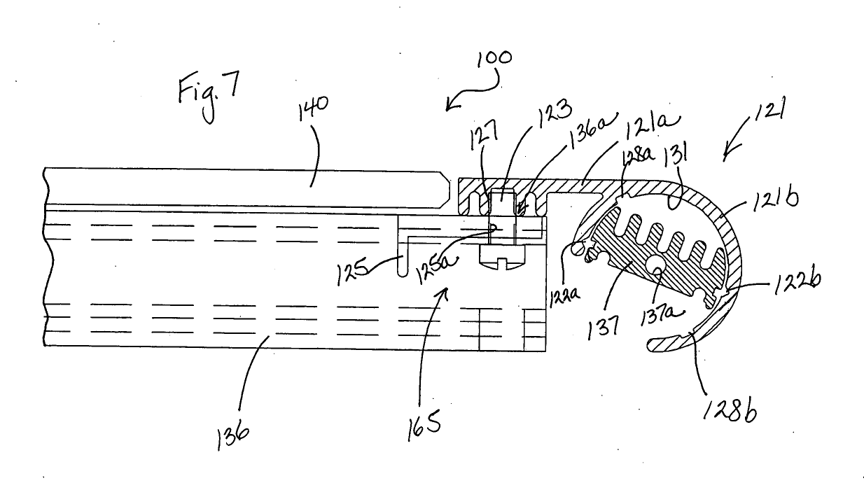

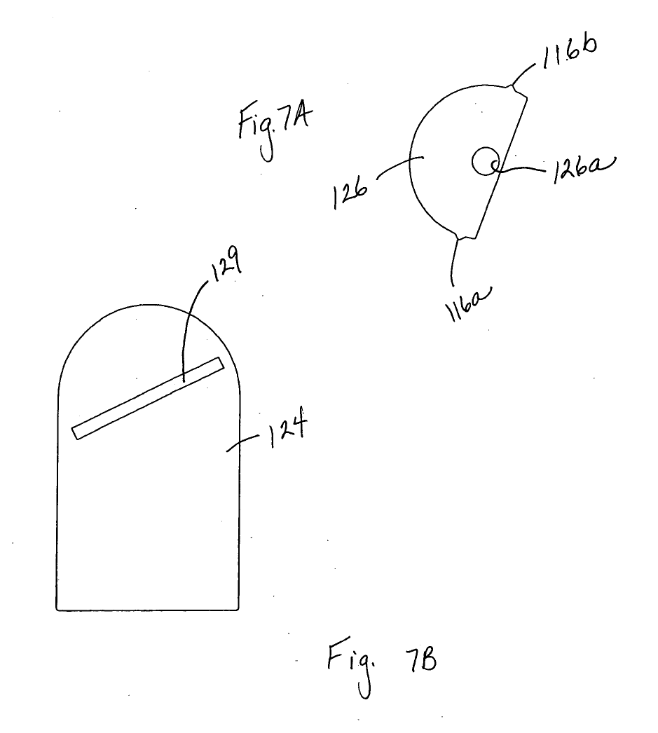

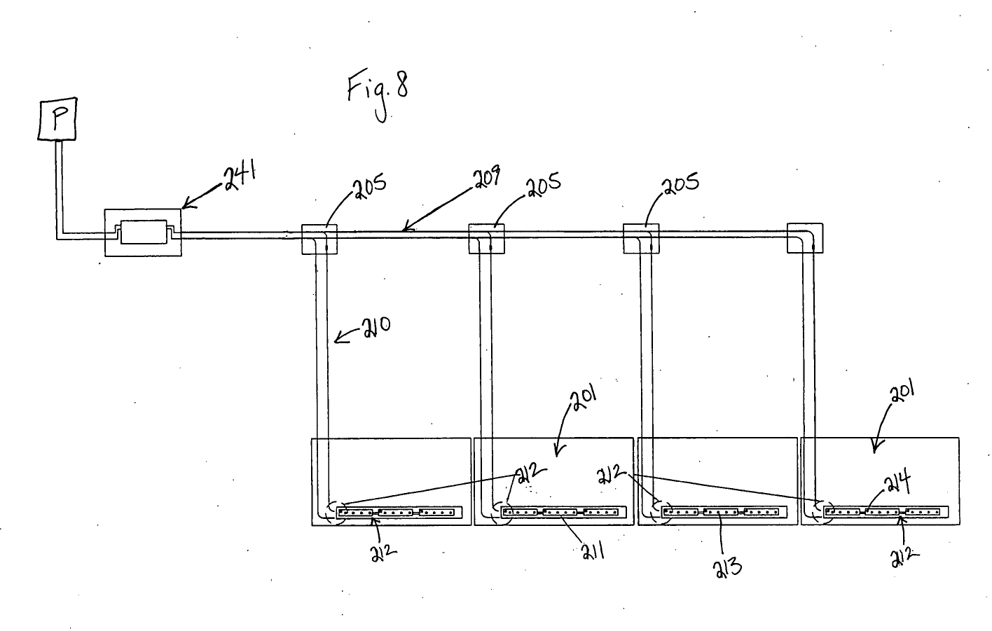

When shelving is used, as shown in FIG. 7, the showcase display assembly 100 also includes at least two shelf supports 136 with bracket members (not shown) operatively connected to standards mounted to the inner surface of the showcase as is well known in the art. The shelf supports 136 are preferably a square tubular member and include a bore 165 and an aperture 136a proximate each of the ends of the top sides of the shelf supports 136. A bottom connecting portion 125 is operatively connected to the top of the shelf support 136 proximate the front end of the shelf support 136, and a rear shelf support (not shown) is similarly connected to the top of the shelf support 136 proximate the rear end of the shelf support 136. The shelf support 136, the rear shelf support, and the bottom connecting portion 125 are configured and arranged to support a shelf member 140 upon which the merchandise is displayed within the showcase.

The lighting is preferably housed within a housing member 121, which is preferably a light reflector made of a reflective material such as anodized aluminum and includes a top connecting portion 121a and a curved portion 121b. The top connecting portion 121a is preferably an elongate plate member, the ends of which are supported by the shelf supports 136 proximate the front ends of the shelf supports 136 and the bottom connecting portion 125. The curved portion 121b curves in a downward direction from the top connecting portion 121a and includes a cavity 131. The top connecting portion 121a is operatively connected to the shelf supports 136 with fasteners 123 inserted through the apertures 136a proximate the ends of the shelf supports 36 and into extruded screw ports 127 in the top front shelf support 121a. The bottom connecting portion 125 is preferably an elongate plate member positioned below the top connecting portion 121a. The bottom connecting portion 125 includes apertures 125a through which fasteners (not shown) are inserted to secure the bottom connecting portion 125 to the top connecting portion 121a.

The curved portion 121b includes axial grooves 122a and 122b. The axial groove 122a is in the inner surface proximate the top of the opening into the cavity 131 and the top front shelf support 121a, and the axial groove 122b is approximately 180 degrees from the axial groove 122a. The curved portion 121b also includes axial grooves 128a and 128b. The axial groove 128a is in the inner surface proximate the juncture of the top front shelf support 121a and the curved portion 121b, and the axial groove 128b is approximately 180 degrees from the axial groove 128a.

A heat sink 137 is preferably an elongate rectangular member including an aperture 137a extending longitudinally proximate the middle of the heat sink 137. A bracket 126 is preferably a semi-circular disk member with an aperture 126a proximate the center of the semi-circle and protrusions 116a and 116b on opposite sides of the aperture 126a, as shown in FIG. 7A. Fasteners (not shown) fasten a bracket 126 to each end of the heat sink 137 through the apertures 126a and 137a. The protrusions 116a and 116b of the brackets 126 are configured and arranged to fit within the axial grooves 122a and 122b, respectively, in the curved portion 121b providing a means to position and orient the heat sink 137 in the housing member 121. The brackets 126 prevent the heat sink 137 from rotating within the housing member 121. End caps 124 are configured and arranged to aesthetically enclose the ends of the housing member 121. The end caps 124 include flanges 129 configured and arranged to fit within the axial grooves 128a and 128b to friction fit into the housing member 121, as shown in FIG. 7B.

In operation, the display assembly 100 is like the display assembly 10 contained within a showcase. The display assembly 100 includes standards having a plurality of apertures (not shown) mounted to an inner surface of the showcase to which bracket members (not shown) are operatively connected to connect at least two shelf supports 136 to the standards. At least one of the standards and at least one of the bracket members are powered by a remote power supply, similarly to that shown in FIG. 5. The bracket members, the shelf supports 136, and the shelf member 140 are adjustable along the standard and are powered by the remote power supply when connected to the standard.

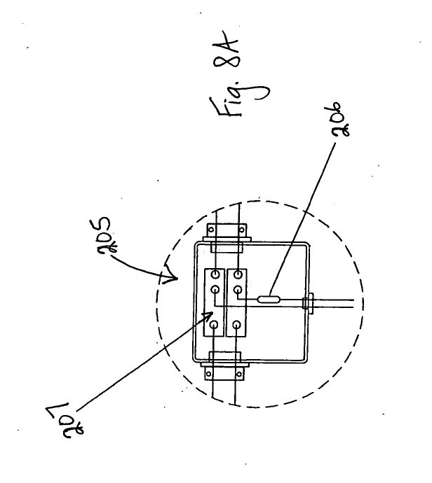

The connection surface in the display assemblies 10 and 100 are the standards, but it is recognized that other types of connection surfaces such as an inner surface of a showcase could also be used with the principles of the present invention. In addition, it is recognized that many display assemblies may be connected to a single remote power supply. As schematically shown in FIG. 8, a board 211 including connectors 212, at least one light emitting diode 213, and a driver 214 is operatively connected to the heat sink 237. The heat sink 237 may include multiple boards 211. The connectors 212 interconnect multiple boards 211 and connect the boards 211 to wires 210, which are wires in the showcase 201 to provide electrical connections to the connectors 212. Preferably, the wires 210 run through the deck in the back of the showcase 201 and to the connectors 212. The wires 210 are operatively connected to a junction box 205, and multiple showcases 201 are preferably interconnected by interconnecting the junction boxes 205 with wires 209. The junction box 205 includes a current limiting fuse 206 and conductors 207. The wires 209 also connect the junction boxes 205 to a power supply 241, which is operatively connected to a power source P.

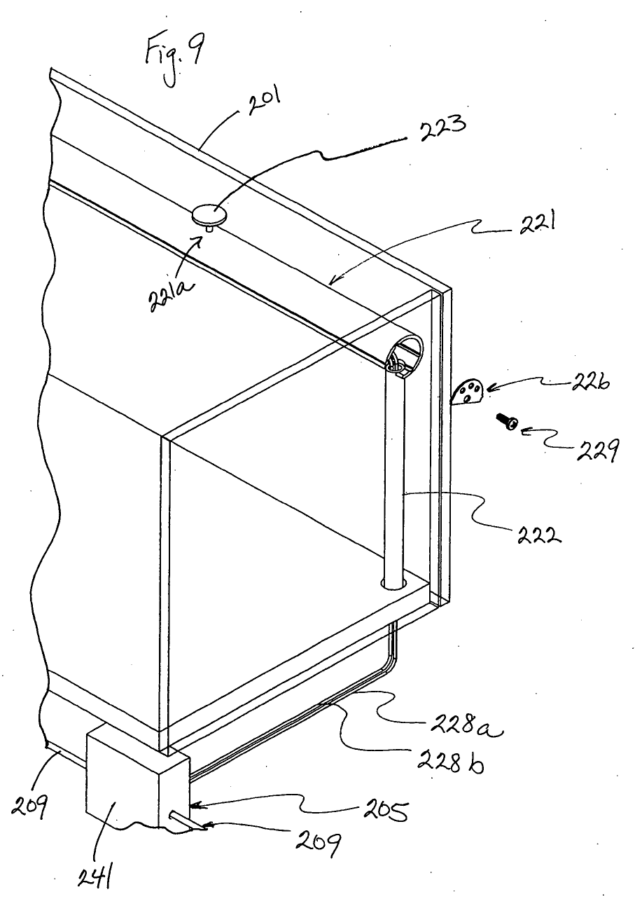

In addition to mounting the housing member proximate the front edges of adjustable shelf members, the housing member 221 may also be mounted proximate the top of the showcase 201, as shown in FIG. 9. The housing member 221 is preferably mounted proximate the top, front corner of the showcase 201 by connecting the top, front surface of the showcase 201 to the top connecting portion 221a with a fastener 223 as is well known in the art. The fastener 223 is an upside down T-shaped member adhesively connected to the underside of the top of the showcase 201 and threaded into the housing member 221. The fastener 223 prevents the middle of the housing member 221 from sagging. A tubular support 222 interconnects each end of the housing member 221 to the floor of the showcase 201 to support the housing member 221 proximate the top of the showcase 201. It is recognized that any suitable support mechanism for the housing member 221 may be used. In addition, wires 228a and 228b run through the tubular support 222 to interconnect the board within the housing member 221 (not shown) to the power supply 241. A bracket 226 is operatively connected to the board with a fastener 229 so that the board does not rotate within the housing member 221. Multiple showcases 201 are powered by the remote power supply 241, as shown in FIG. 8. If adjustable shelves are also used within the showcase 201, there may be a housing member 221 proximate the top, front of the showcase 201 and at the front edges of each of the shelf members.

The lighting of the system is not limited by the size of the driver because there is a driver in each board. Because the driver is separated from the power supply, multiple boards powered by a common remote power supply may be added to and subtracted from the system without affecting the lighting. Rather than wiring the boards to the power supply through the showcase, powered standards similar to those used in the shelving assembly 10 could be used in a showcase type application.

The present invention could be adapted and configured for use with a variety of applications. Generally, one aspect of the present invention utilizes a low voltage electrified slotted standard that fits within the industry-established profile for slotted standards. The low voltage electrified slotted standard can be repackaged for other size applications requiring a low voltage lighted display powered by connecting it to a variation of a slotted standard.

Preferably, the low voltage display assemblies constructed according to the principles of the present invention separate the constant current portion of LED drives, move the constant current device to the LED printed circuit board, and remotely power the assemblies. This enables the display profiles to remain relatively constant and allows a variable number of shelves, a variable width of shelves, and a variable number of lighting devices within the capability of the power supply. The present invention could also be applied to display showcases using the LED reflector(s) and powering multiple showcases with a remote power supply. The present invention could also be applied to existing technology such as multiple display applications requiring small lighted profiles in multiple locations.

The present invention allows for shelves having different widths and different power requirements to be used with the same powered slotted standard while keeping the shelf profile relatively constant because additional drivers do not have to be added. A remote power supply is needed to keep the cross-section of the display assembly the same regardless of the shelf width, the number of lamps, or the number of shelves. The LED drivers consist of two parts, a constant current control and a voltage power supply. Greater flexibility is achieved by splitting the constant current driver from the voltage supply and moving the bulky portion of the voltage supply to a remote location. The constant current driver portion is reduced in size and moved to the LED printed circuit board. Therefore it does not matter how many LED board assemblies are used within the capability of the power supply as long as voltage is set to operate the LED board and the current is controlled at the LED board by the driver.

The present invention provides a powered standard for shelf placement flexibility, allows for changes to the number of shelves, and accommodates power variations of different shelf widths. The display assembly is flexible and modular because the constant current driver has been moved to the LED printed circuit boards on the shelves and because a scalable constant voltage is provided by the remote power supply. The shelves may be adjusted and rearranged without external power reconnection. The assembly has visually the same aesthetic as an industry slotted standard and has no visible cords or wires because all of the power connections are hidden within the components of the display assembly.

The low voltage powered, slotted standard provides a voltage source for the shelves at any of the fixed locations on the slotted standard. The slots in the standard are preferably of a standard spacing (2 inches), height (1 inch), and width (⅛ inch). As shown in FIG. 1, there may be additional cutouts that provide clearance for the shelf contacts on either side of the slot.

The constant current driver is separated from the power supply and reduced in size and placed on printed circuit boards along with the LED emitter lighting sources. The number of LED emitters and the on board constant current driver circuit preferably require a total of 16.5 volts, but it is recognized that the voltage can vary depending upon the number of LED emitters being used. The remote power supply is preferably set to 16.5 volts and the size in Watts can vary to suit the most economical condition for that installation. It is recognized that the voltage depends upon the number of LED emitters that are being used on each printed circuit board. Each LED emitter electrically connected in series generally requires approximately 4 volts per LED emitter constant current circuit. Therefore, the voltage preferably ranges from 4 to 48 volts.

The bracket members inserted into the slotted standards carry a vertical load for merchandising various retail products. The bracket members can be moved and repositioned into any slot on the standard and reconnected to the 16.5 volts power source. The shelf members have provisions to support a clear base such as glass to further provide an unobstructed view of merchandise. The width of the shelf members is variable and for very large widths, multiple standards and bracket members can be added to carry additional load and/or power.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An adjustable display assembly with low voltage powered lighting, comprising:
a) a standard manufactured to an industry profile width and depth, the standard having a front portion and a cavity, the front portion having a plurality of apertures spaced a distance apart along the front portion, the plurality of apertures providing access to the cavity;
b) a low voltage conductor within the cavity of the standard and being accessible through the plurality of apertures along the front portion of the standard, the low voltage conductor being defined by 0.01 to 48.00 volts;
c) a power supply operatively connected to the low voltage connector;
d) a bracket member having an engaging portion, a supporting portion, and a contact member, the engaging portion being configured and arranged to be inserted through at least one of the plurality of apertures and into the cavity to engage the standard, the contact member extending outward from the bracket member proximate the engaging portion, the contact member being configured and arranged to contact the conductor within the cavity when the engaging portion engages the standard, the bracket member being adjustable along the front portion of the standard; and
e) a shelf member supported by the bracket member and housing a lighting device, the lighting device being operatively connected to the contact member, the shelf member being adjustable with the bracket member along the front of the standard and the lighting device being activated when the contact member contacts the conductor.

2. The adjustable display assembly of claim 1, wherein the front portion of the standard is approximately ¾ inch.

3. The adjustable display assembly of claim 1, wherein the plurality of apertures are spaced approximately 2 inches apart and each apertures has a height of 1 inch and a width of ⅛ inch.

4. The adjustable display assembly of claim 1, wherein the shelf member includes a plate member and a housing member, the plate member being configured and arranged to support merchandise, the housing member being configured and arranged to house the lighting device.

5. The adjustable display assembly of claim 4, wherein the lighting device is a light emitting diode and a driver, the driver interconnecting the light emitting diode and the contact member, the housing member housing the light emitting diode and the driver.

6. The adjustable display assembly of claim 1, wherein the lighting device is at least one light emitting diode and a driver, the driver interconnecting the at least one light emitting diode and the contact member.

7. The adjustable display assembly of claim 6, wherein four light emitting diodes are used and the power supply is set to approximately 16.5 volts.

8. The adjustable display assembly of claim 7, wherein the power supply is configured and arranged to be connected to a 110 volts source.

9. The adjustable display assembly of claim 1, wherein the lighting device is selected from the group consisting of a light emitting diode, a halogen lamp, and a xenon lamp.

10. The adjustable display assembly of claim 1, further comprising:
a) a second standard manufactured to an industry profile width and depth, the second standard having a second front portion and a second cavity, the second front portion having a second plurality of apertures spaced a distance apart along the second front portion, the second plurality of apertures providing access to the second cavity; and
b) a second bracket member having a second engaging portion and a second supporting portion, the second engaging portion being configured and arranged to be inserted through at least one of the second plurality of apertures and into the second cavity to engage the second standard, the second bracket member being adjustable along the second front portion of the second standard, the shelf member being supported by the bracket member and the second bracket member.

11. An adjustable display assembly with low voltage powered lighting for use with a standard manufactured to an industry profile width and depth, the standard having a front portion and a cavity, the front portion having a plurality of apertures spaced a distance apart along the front portion, the plurality of apertures providing access to the cavity, comprising:
a) a low voltage conductor within the cavity of the standard and being accessible through the plurality of apertures along the front portion of the standard, the low voltage conductor being defined by 0.01 to 48.00 volts;
b) a power supply operatively connected to the low voltage connector, the power supply being set to 4 to 48 volts;
c) a bracket member having an engaging portion, a supporting portion, and a contact member, the engaging portion being configured and arranged to be inserted through at least one of the plurality of apertures and into the cavity to engage the standard, the contact member extending outward from the bracket member proximate the engaging portion, the contact member being configured and arranged to contact the conductor within the cavity when the engaging portion engages the standard, the bracket member being adjustable along the front portion of the standard; and
d) a housing member supported by the bracket member, the housing member including at least one light emitting diode and a driver, the driver interconnecting the at least one light emitting diode and the contact member, the bracket member being adjustable and the at least one light emitting diode being activated when the contact member contacts the conductor.

12. The adjustable display assembly of claim 11, further comprising a plate member supported by the bracket member, the plate member configured and arranged to support merchandise and being adjustable with the bracket member.

13. The adjustable display assembly of claim 11, wherein the power supply is configured and arranged to be connected to a 110 volts source.

14. The adjustable display assembly of claim 13, wherein four light emitting diodes are used and the power supply is set to approximately 16.5 volts.

15. A display assembly with low voltage powered lighting, comprising:
a) a connection surface having a cavity and an aperture providing access to the cavity;
b) a low voltage conductor within the cavity of the connection surface and being accessible through the aperture, the low voltage conductor being defined by 0.01 to 48.00 volts;
c) a power supply operatively connected to the low voltage conductor, the power supply being set to 4 to 48 volts; and
d) a board including a plurality of light emitting diodes and a driver, the driver interconnecting the plurality of light emitting diodes and the low voltage conductor, the low voltage conductor providing power to any number of boards within the capability of the power supply.

16. The display assembly of claim 15, further comprising a bracket having an engaging portion, a supporting portion, and a contact member, wherein the connection surface is a standard and the aperture is a plurality of apertures spaced a distance apart along the standard, the apertures providing access to the low voltage conductor, the engaging portion being configured and arranged to be inserted through at least one of the plurality of apertures and into the cavity to engage the standard, the contact member extending outward from the bracket member proximate the engaging portion, the contact member being configured and arranged to contact the conductor within the cavity when the engaging portion engages the standard, the bracket member being adjustable along the front portion of the standard.

17. The display assembly of claim 15, further comprising:
a) a second connection surface having a second cavity and a second aperture providing access to the second cavity;
b) a second low voltage conductor within the second cavity of the second connection surface and being accessible through the second aperture, the second low voltage conductor being defined by 0.01 to 48.00 volts;
c) a second board including a second plurality of light emitting diodes and a second driver, the second driver interconnecting the second plurality of light emitting diodes and the second low voltage conductor, the second low voltage conductor providing power to any number of boards within the capability of the power supply, wherein the second low voltage conductor is operatively connected to the power supply.

18. A display assembly with low voltage powered lighting, comprising:
a) a board including a constant current driver circuit and at least one light emitting diode operatively connected to the constant current driver circuit;
b) a low voltage conductor defined by 0.01 to 48.00 volts operatively connected to the constant current driver circuit; and
c) a power supply operatively connected to the low voltage connector, the power supply being set to 4 to 48 volts.

19. The display assembly of claim 18, further comprising:
a) a standard having a cavity and a plurality of apertures spaced a distance apart along the standard, the plurality of apertures providing access to the cavity, the low voltage conductor being housed within the cavity of the standard, the apertures providing access to the low voltage conductor;
b) a bracket having an engaging portion, a supporting portion, and a contact member, the engaging portion being configured and arranged to be inserted through at least one of the plurality of apertures and into the cavity to engage the standard, the contact member extending outward from the bracket member proximate the engaging portion, the contact member being configured and arranged to contact the low voltage conductor within the cavity when the engaging portion engages the standard, the bracket member being adjustable along the front portion of the standard.

20. The display assembly of claim 19, wherein the standard is mounted onto a surface selected from the group consisting of a shelving assembly and a showcase assembly.

21. The display assembly of claim 18, further comprising:
a) a second board including a second constant current driver circuit and a second at least one light emitting diode operatively connected to the second constant current driver circuit;
b) a second a low voltage conductor defined by 0.01 to 48.00 volts operatively connected to the second constant current driver circuit, the second low voltage conductor being operatively connected to the power supply.

22. An adjustable display assembly with low voltage powered lighting, comprising:
a) a first standard manufactured to an industry profile width and depth, the first standard having a first front portion and a first cavity, the first front portion having a first plurality of apertures spaced a distance apart along the first front portion, the first plurality of apertures providing access to the first cavity;
b) a second standard manufactured to an industry profile width and depth, the second standard having a second front portion and a second cavity, the second front portion having a second plurality of apertures spaced a distance apart along the second front portion, the second plurality of apertures providing access to the second cavity;
c) a low voltage conductor within the first cavity of the first standard and being accessible through the first plurality of apertures along the first front portion of the first standard, the low voltage conductor being defined by 0.01 to 48.00 volts;
d) a power supply operatively connected to the low voltage connector, the power supply being configured and arranged to be connected to a 110 volts source, the power supply being set to 4 to 48 volts;
e) a first bracket member having a first engaging portion, a first supporting portion, and a contact member, the first engaging portion being configured and arranged to be inserted through at least one of the first plurality of apertures and into the first cavity to engage the first standard, the contact member extending outward from the first bracket member proximate the first engaging portion, the contact member being configured and arranged to contact the conductor within the first cavity when the first engaging portion engages the first standard, the first bracket member being adjustable along the first front portion of the first standard;
f) a second bracket member having a second engaging portion and a second supporting portion, the second engaging portion being configured and arranged to be inserted through at least one of the second plurality of apertures and into the second cavity to engage the second standard, the second bracket member being adjustable along the second front portion of the second standard, the shelf member being supported by the bracket member and the second bracket member; and
g) a housing member supported by the first bracket member and the second bracket member, the housing member including at least one light emitting diode and a driver, the driver interconnecting the at least one light emitting diode and the contact member, the first bracket member and the second bracket member being adjustable and the at least one light emitting diode being activated when the contact member contacts the conductor.

23. The adjustable display assembly of claim 22, wherein four light emitting diodes are used and the power supply is set to approximately 16.5 volts.

24. The adjustable display assembly of claim 22, further comprising a plate member supported by the first bracket member and the second bracket member, the plate member configured and arranged to support merchandise and being adjustable with the first bracket member and the second bracket member.
